(19) United States
(12) Patent Application Publication
(10) Pub. No.: US 2015/0047256 A1
(43) Pub. Date: Feb. 19, 2015

(54) Vertical Gardening Apparatus and Method

(71) Applicant: Michael H. Redler, Bridgewater, NJ (US)

(72) Inventor: Michael H. Redler, Bridgewater, NJ (US)

(21) Appl. No.: 14/061,724

(22) Filed: Oct. 23, 2013

Related U.S. Application Data
(60) Provisional application No. 61/866,381, filed on Aug. 15, 2013.

(51) Int. Cl. A01G 9/02

(52) U.S. Cl. CPC A01G 9/021; A01G 9/02
USPC 47/65.7; 47/65.5; 29/891

(57) ABSTRACT

A vessel for containing, cultivating and suspending plants. The vessel consolidates and reduces the time necessary for the process of sowing seeds, transplanting plants, growing plants, recycling plant materials, dismantling and storage, by simplifying and reducing the number of process steps.

### CROSS REFERENCE TO RELATED APPLICATIONS

This application claims benefit to U.S. provisional application 61/866,381, which is incorporated by reference herein in its entirety.

### BACKGROUND OF THE INVENTION

1. Field of the Invention

The present invention is directed to a device for cultivating plants in their natural upright orientation or in an inverted, root-end-up orientation, or in simultaneous combinations therein, with multiple plants being cultivated in both orientations for the purposes of, for example, vertical gardening. This invention is concerned with all stages of plant cultivation, from the germination of seeds to the fully mature plant, as well as the effective recycling of plant matter at the end of the growing season.

2. Description of the Related Art

For some time it has been recognized that the cultivation of plants above ground can improve the yield of some vegetable plants, can reduce damage from parasites, and for those tending to plants, it can reduce the risk of back strain and injury due to bending over.

During cultivation, it is vital to keep the plant fed and watered. Any obstructions to that objective can increase the time necessary to produce a healthy plant. Many examples of prior art requires the user to interact in close proximity to the planter. In other words, the plant cannot be properly watered from a distance.

A plant-growing apparatus like the ones shown in many examples of prior art, are suited for small-scale gardeners, but are economically and practically unfeasible or undesirable for some larger scale applications, such as subsistence farming. Many involve multiple pieces that require positioning the plant through a hole. Other examples of prior art use lanyards or wires to suspend a planter. The obstruction created by suspending a planter directly above the opening through which planting materials are introduced can increases preparation time.

### SUMMARY OF THE INVENTION

It is an aspect of the present invention to provide an improved planting system.

Another aspect of the invention is to incorporate a modular construction so as to allow two identical devices to be interconnected and become integral halves of a larger apparatus, expanding the volume in which to cultivate plants.

Another aspect of the invention is a method for quickly assembling and disassembling a planter from around the plant so as to expedite use as a viable small-scale farming accessory.

Another aspect of the invention is to provide a means by which to disassemble, recover used plant matter and planting medium, and prepare for storage in a single operation.

Another aspect of the invention is to provide a path through which excess water and other liquid materials can easily exit the volume in which the cultivation of plants occur, so as to mitigate root disease, fungus and rot. The method of construction and the resulting geometry effectively provides drainage for liquids. Particularly, an apparatus which is assembled or wrapped around a plant will leave a seam along the length of the apparatus. The gap along the seam is such that liquids can escape and other organic matter may stay contained. The orientation of the apparatus is such that gravity will cause liquids to migrate toward the seam, thereby providing the necessary elements for proper drainage.

Another aspect of the invention is to provide the plant with as much exposure to the sun as possible. By extension, the method of suspending a plant will not impede any light from reaching the plant, irrespective of its orientation. The method of suspension does not involve lanyards or other methods, for example, which can block sunlight, as is the case with numerous examples of prior art. Further, the method of suspension provides a surface by which light can be reflected toward the plant. Further, the method of suspension provides a surface and an orientation by which water can be deflected and directed toward the plant, thereby reducing waste and reducing the time necessary to maintain a plant. Further, the method of suspension does not involve lanyards or other methods, for example, which can impede the introduction of planting medium into the apparatus such as dirt, potting soil, and hydroponic growing medium, as is the case with numerous examples of prior art.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1A is a flat-panel view of a vertical gardening apparatus, according to an embodiment;

FIG. 1B is an enlarged view of a button caught in a respective buttonhole, according to an embodiment;

FIG. 2 is a flat-panel view of a vertical gardening apparatus showing the orientation of a plant prior to assembly, according to an embodiment;

FIG. 3 is a partially assembled view of a vertical gardening apparatus showing the partial formation of a cone around a plant, according to an embodiment;

FIG. 4 is a partially assembled view of a vertical gardening apparatus showing the full formation of a cone around a plant, according to an embodiment;

FIG. 5 is a front view of a fully assembled vertical gardening apparatus showing a plant in an inverted or root-end-up orientation, according to an embodiment;

FIG. 6 is a side view of a fully assembled vertical gardening apparatus showing a plant in an inverted or root-end-up orientation, according to an embodiment;

FIG. 7 is a front view of a fully assembled vertical gardening apparatus showing a plant in an upright or root-end-down orientation, according to an embodiment;

FIG. 8A is a side view of a fully assembled vertical gardening apparatus showing a plant in an upright or root-end-down orientation, according to an embodiment

FIG. 8B shows an alternative button and buttonhole arrangement, and demonstrates how a variety of buttonhole shapes can function in ways which are substantially similar to one another.

FIG. 8C shows the alternative button and buttonhole arrangement shown in 8B with the button removed.

FIG. 9A is a flat-panel view of a composite two-panel embodiment of a vertical gardening apparatus, according to an embodiment;

FIG. 9B shows how two panels can be curled in order to form a larger conical apparatus;

FIG. 10 is an isometric view of an assembled composite two-panel embodiment of a vertical gardening apparatus. This does not incorporate the plant, growing medium, or how it is suspended, according to an embodiment;

FIG. 11 is a front view of a fully assembled composite two-panel embodiment with a plant in an inverted or root-end-up orientation, according to an embodiment;

FIG. 12 is a side view of a fully assembled composite two-panel embodiment with a plant in an inverted or root-end-up orientation. One of two elevated structures has been removed for clarity, according to an embodiment;

FIG. 13 is an isometric view of a fully assembled composite two-panel embodiment with a plant in an inverted or root-end-up orientation, according to an embodiment;

FIG. 14 is a front view of a fully assembled composite two-panel embodiment with a plant in an upright or root-end-down orientation, according to an embodiment;

FIG. 15 is a side view of a fully assembled composite two-panel embodiment with a plant in a non-inverted or root-end-down orientation. One of two elevated structures has been removed for clarity, according to an embodiment; and

FIG. 16 is an isometric view of a fully assembled composite two-panel embodiment with a plant in a non-inverted or root-end-down orientation, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

A vertical gardening apparatus comprising a flexible rectangular sheet, manufactured from a non-corrosive metal, such as aluminum. A first set of holes along a first side, and a second set of buttonholes along a side adjacent to the first side. A third and fourth side adjacent to the first and second side, respectively, completes the rectangle. Buttons are fastened to each hole in the first set of holes. The buttons pass through the second set of buttonholes and function as a fastening device. The flexible rectangular sheet is rolled to form a cone and the buttons are joined with the second set of buttonholes to maintain a cone shape. A mounting hole is located along a line which bisects the third and fourth side, passing through the location where the third and fourth side intersect and provides a method by which the apparatus in its final form can be suspended. Note that the flexible sheet can be formed using other shapes besides rectangular, such as square, trapezoidal, polygonal, etc.

According to one embodiment, a plant is placed upon the flexible rectangular sheet prior to forming the cone, with the stem being substantially collinear with a line that bisects the third and fourth side. This defines a method by which a cone can be formed around a plant. The plant is oriented such that the roots and part of the stem is contained inside the cone and the remainder of the plant extends through an opening at the small end of the cone, whereby the opening of the cone is substantially smaller than the root structure of the plant and prevents the plant from falling out of the cone. The cone, having a large side and a small side, is oriented with the small side at the bottom, and is suspended from the mounting hole near the large side, or top of the cone. This places the plant in an inverted or root-end-up orientation. The volume inside the cone is filled with growing medium such as dirt or potting soil. As the dirt settles, the cone shape compacts the dirt and prevents it from falling out the bottom. The growing medium applies pressure against the inside wall of the cone due to gravity, which further maintains the shape of the cone and contributes toward maintaining the fastened position of the buttons.

According to another embodiment, the volume inside the cone is filled with growing medium such as dirt or potting soil. The small end or bottom of the cone provides drainage of excess liquids. A plant is placed in the planting medium in the large opening near the top of the cone in its natural orientation, with the roots embedded in the growing medium and the remainder of the plant extending upward.

According to yet another embodiment, a vertical gardening apparatus comprising a first and second flexible rectangular sheet. Each sheet is identical to previous embodiments described in this disclosure. Buttons are fastened to each hole in the first set of holes of each sheet. The buttons fastened to the first sheet, pass through the second set of buttonholes of the second sheet and function as a fastening device. The buttons fastened to the second sheet, pass through the second set of buttonholes of the first sheet and also function as a fastening device. The two interconnected sheets form a cone. The cone, having a large end and a small end, is oriented with the small end at the bottom, and is suspended from two mounting holes near the large end, or top of the cone. A mounting hole is located on each sheet along a line which bisects the third and fourth side of each sheet, and is substantially close to the corner where the third and fourth side intersect on each sheet. The orientation of the holes are in a radial position opposite one another.

Various illustrative embodiments and examples of a vertical gardening apparatus according to aspects of the invention will now be described in more detail.

It is to be appreciated that the term “vertical gardening apparatus” as used herein refers to a device capable of cultivating plants for gardening and small-scale farming about an elevated structure, such as a wall or the side of a building. The device may include features for enhancing or reinforcing its ability to cope with stresses and strains related to suspending plants and growing materials. Examples of such enhancements include, but are not limited to gussets, ribs, reinforcement rings or grommets for mounting holes.

Additionally, the term “vertical” as used herein describes the fact that the device is primarily intended to cultivating plants along a vertical plane, such as a wall or the side of a building. It is to be understood that the invention is not limited in its application to the details of construction and the arrangement of components set forth in the following description or illustrated in the drawings.

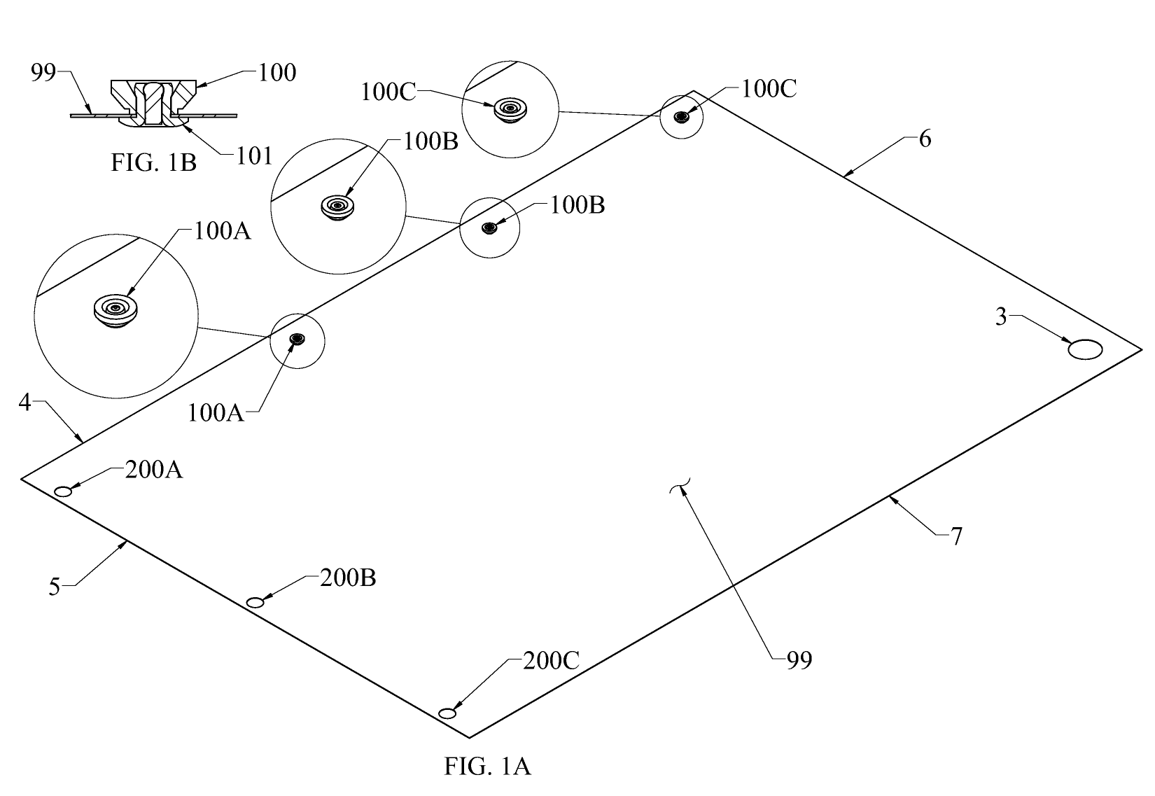

Although the following discussion will assume that the method of maintaining a cone-shaped structure utilizes a fastening mechanism comprising a button and a round buttonhole combination, it is to be appreciated by anyone with skill in the art that there are other fastening mechanisms that can be used for obtaining the same or similar results. Examples of other fastening mechanisms include but are not limited to slotted buttonholes, flexible buttons, and snaps used in the clothing industry, hooks with a cooperating hole or latch, Velcro, etc. Alternative situations contemplated by those of skill in the art are intended to be considered part of this disclosure. Note that each fastening mechanism has a first fastening mechanism and a second cooperating fastening mechanism, for example a button (first fastening mechanism) and a second cooperating fastening mechanism (hole/buttonhole) but the nomenclature can also be reversed (the button can be the second cooperating fastening mechanism) and the hole can be the first fastening mechanism. While the first fastening mechanisms and second cooperating fastening mechanisms are typically different objects (e.g., button and hole, etc.), in some embodiments, the first fastening mechanism and the second cooperating mechanism can be the same type of object (e.g., if hooks are used the same type of hook can be used as the first mechanism and the cooperating second mechanism whereas the two hooks would catch onto each other). Also note that while FIG. 1A (and other figures) depict a sheet with three first fastening mechanisms (e.g., buttons) and three second cooperating fastening mechanisms (e.g., holes) it can be appreciated that other numbers of fastening mechanisms can be used as well and can also be placed in different locations than illustrated.

Other embodiments and manners of carrying out the invention are possible. Also, it is further to be understood that the phraseology and terminology used herein is for the purpose of description and should not be regarded as limiting. The use of “including,” “comprising,” or “having” and variations thereof is meant to encompass the items listed thereafter and equivalents thereof as well as additional items.

Referring to FIG. 1A, there is illustrated an unassembled plan view of one embodiment of a vertical gardening apparatus according to certain aspects of the invention. The condition of the apparatus in this view may be defined as a flat-panel, where prior to being formed into any shape, it describes the flattened condition of the device. Further, a flat-panel may be a desirable state of preparation for shipment, sales, or storage, or any other situation where the apparatus is not in use. A flat-panel may be defined as a flat sheet of a flexible material such as aluminum with a thickness of 1/100^{th} of an inch (although of course other thicknesses can be used). The flat-panel should be firm yet bendable so that it can be manually curled in the cone-shape discussed below.

The flat-panel 99 clearly shows the location of buttons 100a, 100b, 100c and the corresponding buttonholes 200a, 200b, 200c by which the conical shape of the apparatus can be sustained. A button is defined as a round piece of plastic or metal that is permanently attached to the flat-panel with a fastener such as a rivet, and which is pushed through a buttonhole so as to attach one section of the flat-panel to another. A rivet, as used herein, is defined as a headed pin or bolt of metal which is passed through a hole in two or more pieces, and then deforming the plain end so as to make a second head, capturing the two or more pieces between the two heads. The end of the button which is pushed through the buttonhole has a larger area than the end which is permanently attached to the flat-panel. The larger area of the button, when pushed through the buttonhole, will catch the edge of the buttonhole upon any lateral movement of the buttonhole or button. See FIG. 1B which shows a button 100 permanently attached to the flat panel 99 by a rivet 101 (the button and rivet are integrated). The type of rivet used herein (although any type of rivet can be used) is known to those skilled in the art as a “blind rivet”, and unlike solid rivets, are tubular and include a mandrel through the center. Deformation at one end of the rivet occurs when tension is applied to the mandrel at the opposite end through the use of a rivet gun. The button can be slightly deformable (e.g. plastic) so that it can squeeze into a corresponding buttonhole.

In FIG. 1A, the buttons are “face up” (the button is on the top side of the flat-panel as illustrated as 100a, 100b, 100c) although they can be in a face down orientation as well. The apparatus, when assembled, is curled up so that button 100a catches onto buttonhole 200a, button 100b catches onto buttonhole 200b, and button 100c catches onto buttonhole 200c. Also illustrated is mounting hole 3 which is located along a line which bisects the third side 6 and the fourth side 7 by which the fully formed apparatus is to be suspended. Mounting hole 3 can be used, for example, to hang the apparatus on a hook, string, etc. A long side 4 of the flat panel with the buttons and a short side 3 of the flat panel with the buttonholes is shown.

The button 100a is pushed through the buttonhole 200a by a user. Likewise, button 100b is pushed through buttonhole 200b and button 100c is pushed through buttonhole 200c, joining the first side 4 to the second side 5, thereby forming a cone. It is noted that other connection mechanisms can be used as well to connect the respective sections of the flat-panel, such as snaps, adhesives, etc.

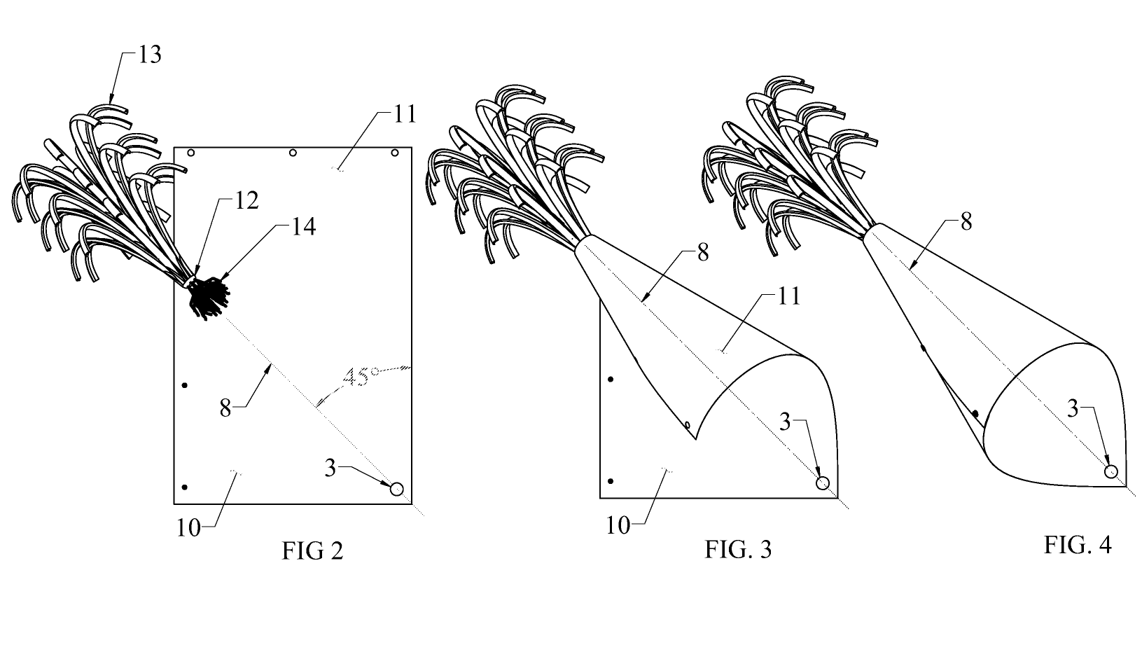

Note that the apparatus can exist as a flat-panel (e.g., flat metal sheet as illustrated in FIG. 2) until it is rolled up into a cone-shaped apparatus (as illustrated in FIG. 4).

Referring to FIG. 2, there is illustrated a flat-panel embodiment of the apparatus and a plant 12, 13, 14, as it would be placed in preparation for the final assembly as illustrative of one embodiment. The plant comprises the stem 12, vegetation 13, and roots 14. Placement of the plant is such that the stem 12 is substantially collinear with a line that bisects the third side 6 and fourth side 7 of the flat-panel. The shape of the flat-panel as described in this embodiment is rectangular, causing the angle of the bisecting line 8 to be 45 degrees. The bisecting line divides the flat-panel into two parts, which may be defined as a small area 10 and a large area 11. Further, the plant is oriented in a manner which has the roots 14 being in direct contact with the flat-panel and the vegetation 13 extending beyond the perimeter of the flat-panel.

Referring to FIG. 3, there is illustrated a view of a partially developed apparatus, with the large area 11 of the flat-panel rolled toward the small area 10 until the rolled curvature has affected the entire large area 11 of the flat-panel and has become substantially cone-shaped. The curvature of the flat-panel (no longer flat) being substantially cone-shaped, the center axis of the cone-shape can reside on a plane which is perpendicular to where the flat-panel was and along a bisecting line 8.

Referring to FIG. 4, there is illustrated a view wherein the flat-panel has been completely rolled up into a cone shaped apparatus. The small area 10 is rolled until the resulting curvature has become cone-shaped in a manner similar to the large area 11. The center of the cone generated from the small area 10 is collinear with the center of the shape generated from the large area 11. The resulting shape of the apparatus is such that the buttonholes 200a, 200b, 200c residing in the large area 11 are substantially aligned with the buttons 100a, 100b, 100c residing in the small area 10.

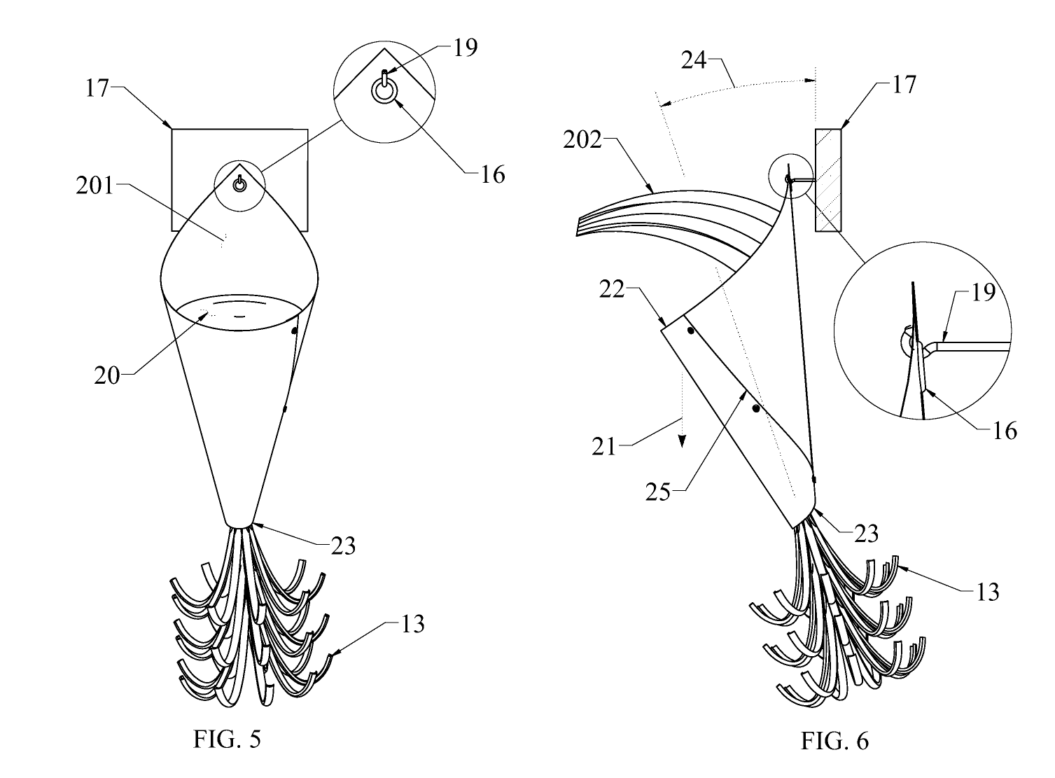

Referring to FIG. 5, there is illustrated a front view of a fully assembled vertical gardening apparatus (the apparatus) with a plant growing from the bottom of the apparatus in an inverted or root-end-up orientation. The apparatus shown is the cone-shape apparatus from FIG. 4 with a plant inside. Further, this embodiment incorporates a reinforcement ring 16 which is attached to the mounting hole 3. The apparatus is suspended from an elevated support structure 17 by a hook 19. The reinforcement ring 16 enhances the amount of weight that the mounting hole 3 can tolerate and prevents the hook 19 from tearing the mounting hole 3.

The apparatus having been assembled in a manner shown in FIGS. 2, 3 and 4, whereby the flat-panel is formed into a cone-shaped structure around the plant, and the buttonholes 200a, 200b, 200c are connected to respective buttons 100a, 100b, 100c. The flexibility of the material used to form the apparatus “remembers” its natural shape and causes the cone-shaped structure to return to a flat-panel configuration when the buttons are disconnected from their respective buttonholes (this can be done by manually pushing the buttons through its buttonhole). When formed to create the cone-shaped structure, the material reacts to its curvature with a lateral force along the periphery of the cone which is applied to each button by its corresponding buttonhole (when attached). This is the mechanism by which the buttons remain secured to their respective buttonholes and the cone-shaped structure can be maintained. The interior of the cone-shaped structure contains a plant growing medium 20 such as potting soil or dirt for plant cultivation. The downward force of the growing medium 20 further helps maintain the cone-shape of the apparatus by providing outward pressure to the inner walls of the apparatus due to gravity.

The opening at the bottom of the cone-shaped structure 23 is smaller than the root 14 of the plant (not visible in FIG. 5 since it is being the cone-shaped apparatus), preventing the plant from falling out of the apparatus. As a result of gravity, the cone-shaped structure guides any growing medium 20 toward a gradually decreasing area as it settles between the interior of the cone-shaped structure and the roots 14 of the plant, compacting the materials around the plant at the roots and further preventing it from falling out of the apparatus. The descent and compaction of growing medium near the bottom of the cone-shaped structure occurs irrespective of the orientation or location of the plant.

Referring to FIG. 6, there is illustrated a side view of a fully assembled apparatus with a plant growing from the bottom 23 of the apparatus in an inverted or root-end-up orientation (in other words the plant is growing upside-down). The center of gravity and the location of the mounting hole 3 of a fully assembled vertical gardening apparatus will cause the apparatus to lean forward 24 as it is suspended by a hook 19 from an elevated support structure 17. The apparatus includes a seam 25 resulting from the area where the small area 10 and large area 11 make contact. The orientation 24 directs liquids in the interior of the apparatus toward the seam 21. The seam is where the long side 4 of the flat panel with the buttons meets the short side 5 of the flat panel with the buttonholes. The seam is a slit and allows liquids to pass through and solid matter to stay contained, resulting in a method of drainage which occupies the entire length of the cone-shaped structure.

A particular area of the interior of the cone-shaped structure may be defined as the deflection area 201 and is used to collect and deflect water and other liquids 202 into the interior of the apparatus and more specifically, a small reservoir 22 which is an area at the front and between the upper rim of the structure and the top surface of the planting medium (above the dirt). Thus, the plant 12, 13, 14 can be watered (using a hose, etc.) by delivering liquids to a substantially larger area 201 above the area in which it is absorbed by the plant so that it may be deflected downward and into the apparatus. Further, the deflection area 201 can enhance the amount of light received by the plant for photosynthesis by reflecting light toward the plant. The material that the flat-panel (and hence the cone-shaped apparatus) is made of can be a polished aluminum which has high reflective qualities which would enhance the light reflected off the deflection area 201 and onto parts of the plant.

Shown in FIGS. 5-6 is the plant which is grown in an upside-down orientation (the roots 14 on top and the vegetation 13) of the plant on the bottom which is opposite to how plants typically grow on the ground (with roots on the bottom and the vegetation on top).

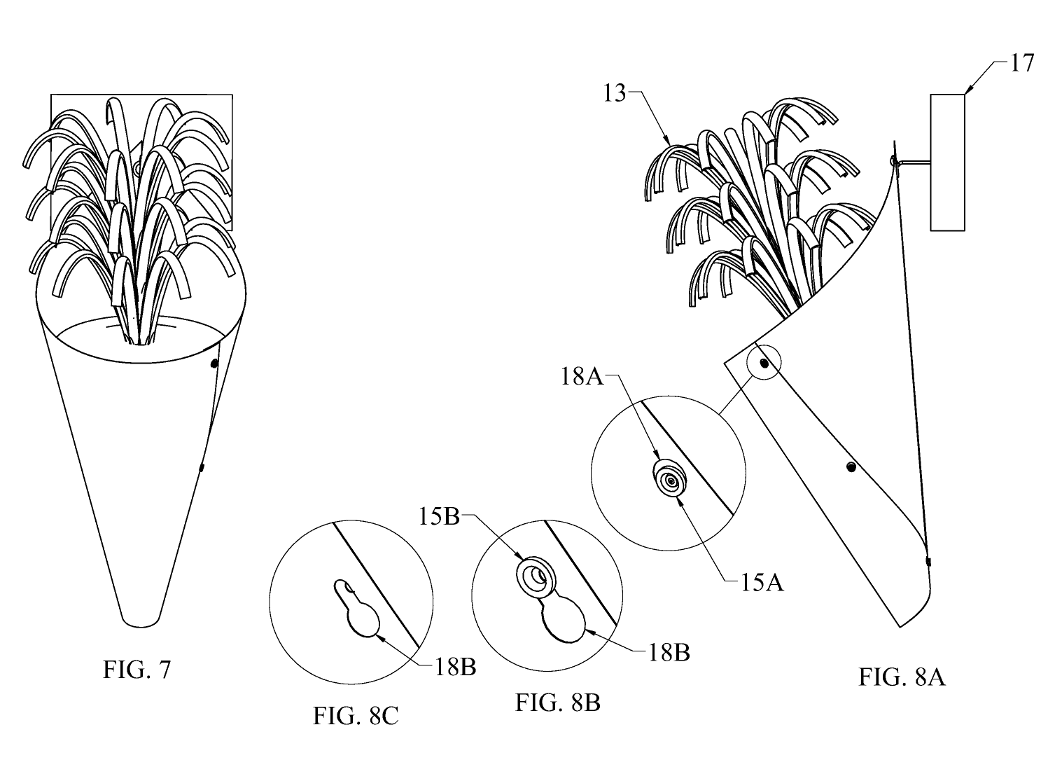

Referring to FIG. 7, there is illustrated a front view of an alternate embodiment with a plant in an upright or root-end-down orientation. Note that the same apparatus can also be used to grow a plant in the upright, traditional orientation.

Referring to FIG. 8A, there is illustrated a side view of an alternate embodiment with a plant in an upright or root-end-down orientation. Orientation of the apparatus is similar to the one shown in FIG. 6, except when the vegetation 13 of the plant becomes substantially larger because the size, shape and weight of the plant can change the center of gravity of the apparatus. Note that the button 15A and buttonhole 18A connection is shown with one edge of the buttonhole caught against the button thus illustrating one method of fastening the apparatus and maintaining the cone-shaped structure.

Referring to FIG. 8B, FIG. 8B shows a keyhole configuration in which the button 15B can be inserted into a bottom portion of a keyhole 18B and then slid upward into a locked position. Note that a buttonhole as described herein is defined as a hole through which a button can be passed, then caught or locked into position to form a fastened joint. As such, the buttonhole is not limited by shape or size but by its ability to perform the catching or locking action described herein. An example of a buttonhole which incorporates a catching action is a simple round hole. An example of a buttonhole which incorporates a locking action is one shaped like a keyhole. Note that typically a button can also be removed from its respective buttonhole (by a user) by simply pushing the button through the buttonhole (or sliding the button in the case of the configuration illustrated in FIG. 8B) and then pushing the button through. Thus, the mechanically fastened joint comprised of buttons and their buttonholes should be considered “removable”. As such, any constructed apparatus described herein can be easily dismantled and flattened for storage and transport.

Referring to FIG. 8C, the keyhole configuration is shown without the button which shows a bottom circular portion connected to a slot. The button enters the bottom circular portion and then is slid along the slot to secure the button.

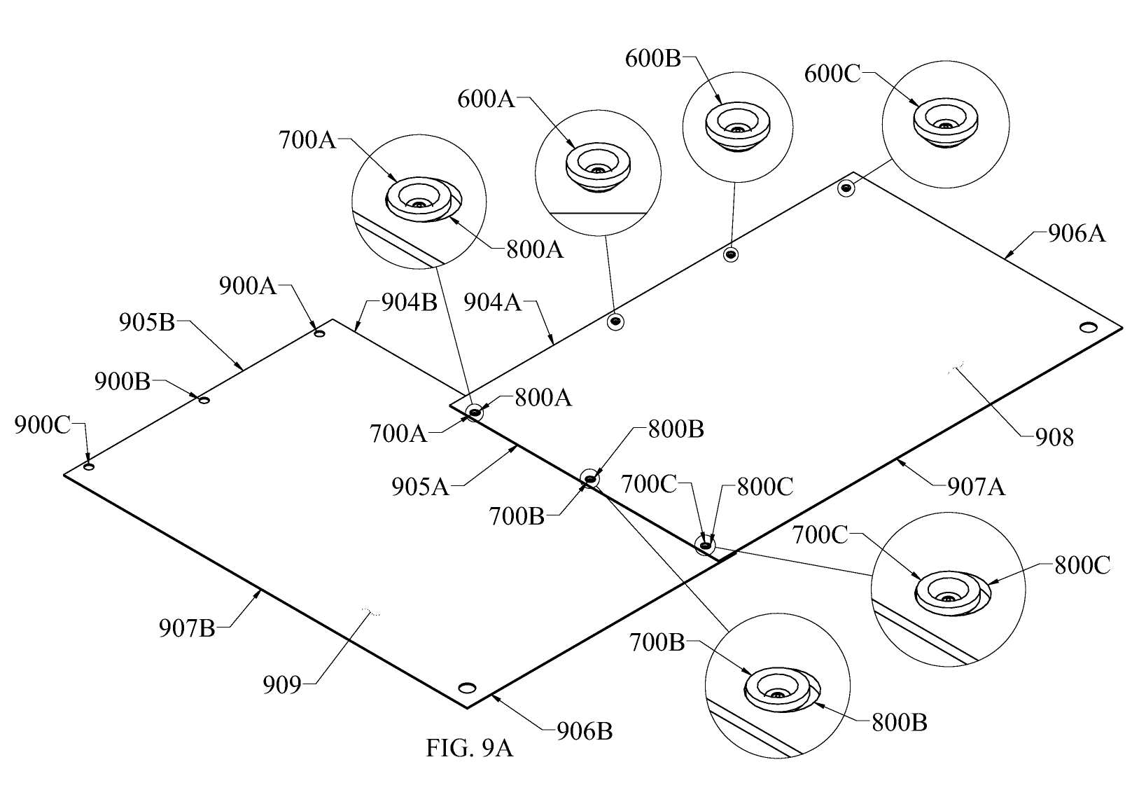

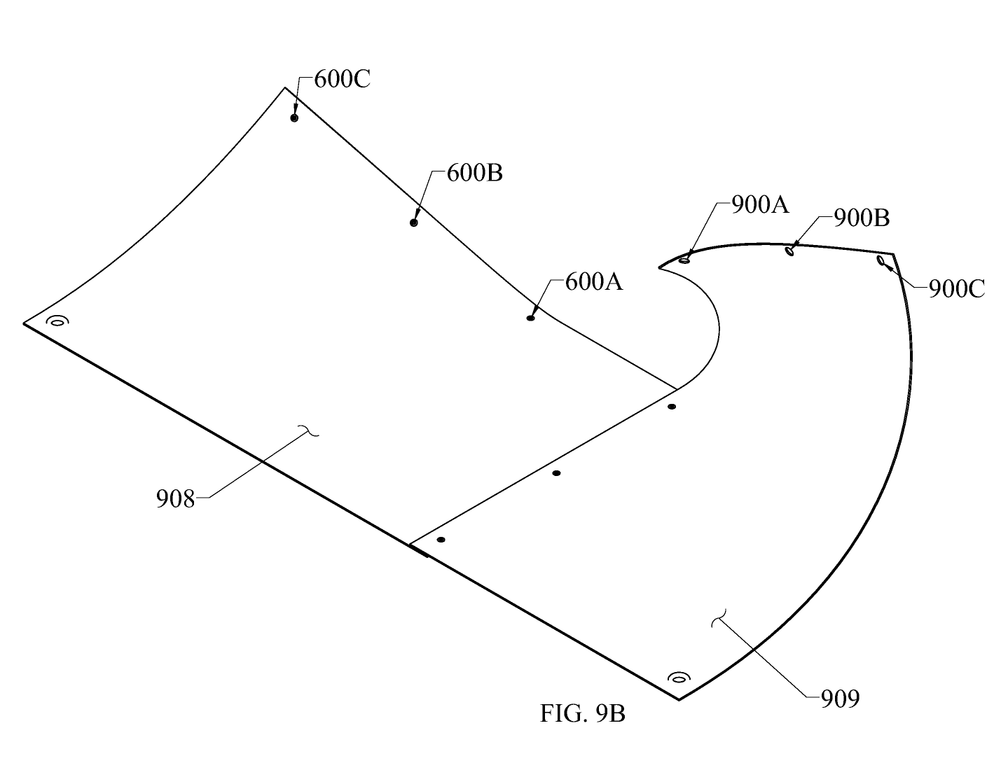

Referring to FIG. 9A, there is illustrated a view of an alternate embodiment of a vertical gardening apparatus, comprising two identical flat-panels as described in earlier examples. The two flat-panels are the same as previously illustrated and are interconnected using buttons and respective buttonholes as described herein. Two flat-panels can be combined thus creating a larger cone-shaped apparatus which can be used in the same manner as the cone-shaped apparatus described herein. A first panel 908 has integrated buttons 600A, 600B, 600C and buttonholes 800A, 800B, 800C. A second panel 909 has integrated buttons 700A, 700B, 700C and buttonholes 900A, 900B, 900C. Buttons 700A, 700B, and 700C are configured to catch buttonholes 800A, 800B, 800C. Buttons 600A, 600B, 600C are configured to catch buttonholes 900A, 900B, 900C (when the panels are curled over so the side of the second panel 909 with the buttonholes 900A, 900B, 900C can touch the side of the first panel 908 with the buttons 600A, 600B, 600C. The first panel 908 and the second panel 909 are identical. Note that all integrated buttons illustrated herein can look like FIG. 1B.

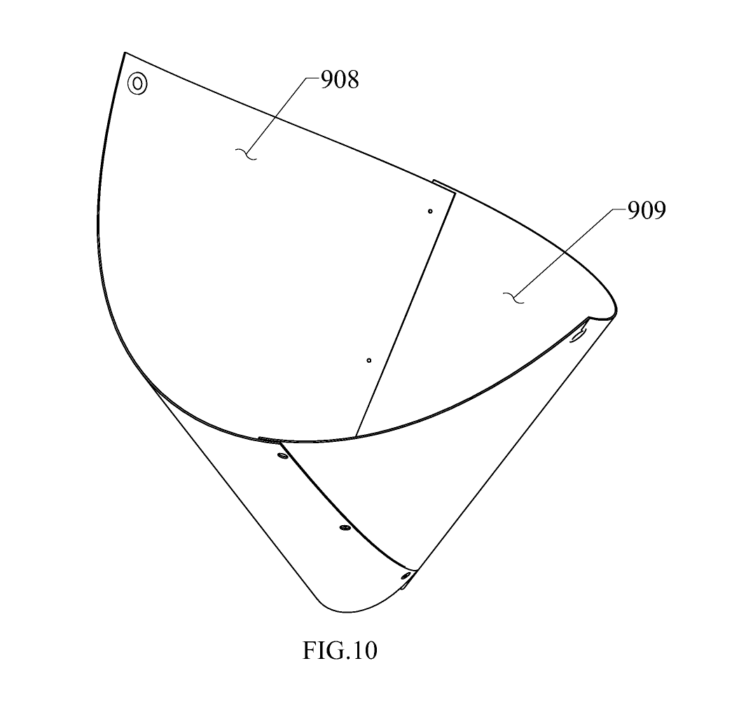

Referring to FIG. 9B, this shows how both panels can be curled in order to form the conical apparatus illustrated in FIG. 10.

Referring to FIG. 10, there is an isometric view of an alternative embodiment comprising two identical flat panels and demonstrating a modular construction of a vertical gardening apparatus (a conical apparatus). Each component is independently capable of being a vertical gardening apparatus 99. In other words, the apparatus shown in this figure can be disassembled and made into two separate devices having half the total surface area (when flat) of the larger apparatus from which it came. The components are interconnected by utilizing the button and buttonhole mechanism as described in previous embodiments. The remaining button and buttonholes are then brought together to form a larger cone-shaped structure. The conical apparatus formed by two panels can be used with any embodiment described herein.

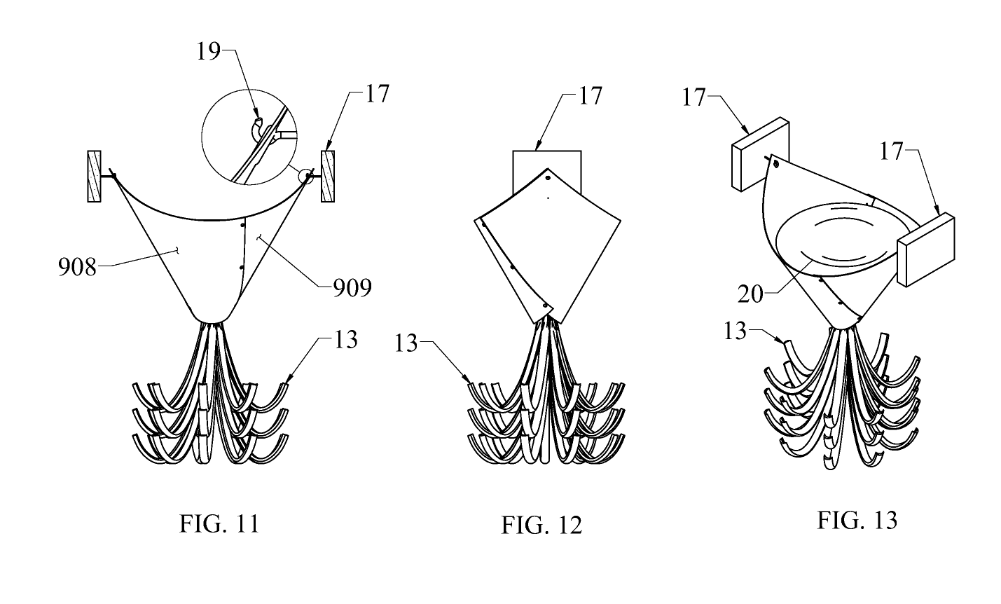

Referring to FIG. 11, shown is a front view of the device shown in FIG. 10 as a final assembly, illustrating the use of growing medium and suspended from an elevated support structure 17 by two hooks 19. In this embodiment, the plant is placed in an inverted or root-end-up orientation, and functionally differs from FIGS. 5 and 6 in that there are two locations from which to suspend the device. The front view illustrates the substantially equal weight distribution between the two hooks on which the device is suspended. FIG. 12, is a side view of the device shown in FIG. 11 and illustrates the symmetry of the device while in use. FIG. 13 is an isometric view of the device shown in FIGS. 11 and 12 and clearly represents how the device is to be suspended at two locations from an elevated support structure 17 by two hooks 19.

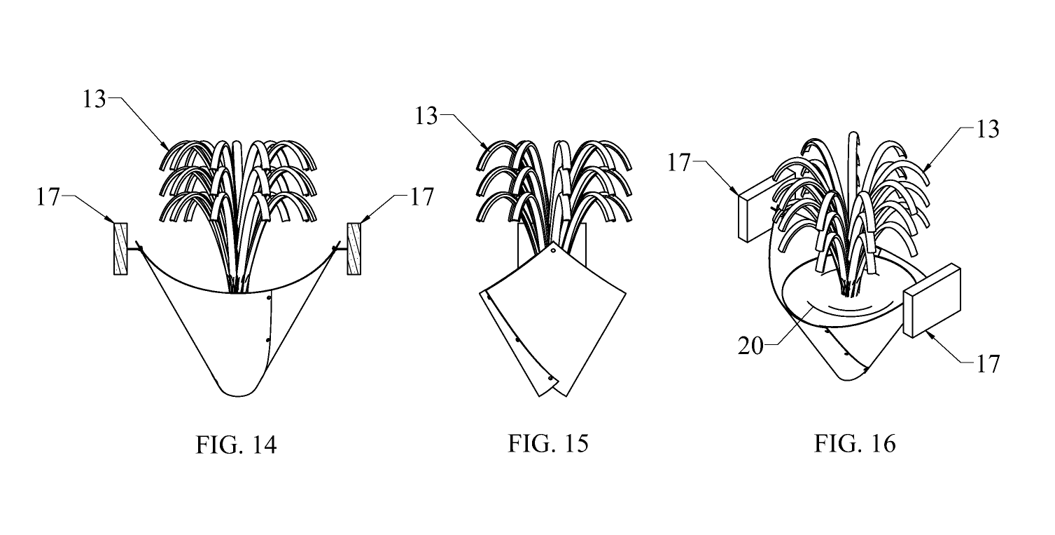

Referring to FIG. 14, shown is a front view of an alternative embodiment to the device shown in FIG. 11, and functionally differs from the device shown in FIG. 11 in that the plant is placed in a non-inverted or root-end-down orientation (the traditional upright orientation). The front view illustrates the substantially equal weight distribution between the two hooks on which the device is suspended. FIG. 15 is a side view of FIG. 14 and illustrates the symmetry of the device while in use. FIG. 16 is an isometric view of the device shown in FIGS. 14 and 15 and illustrates how the device can be suspended at two locations from an elevated support structure 17 by two hooks 19.

It is to be appreciated that although this and other embodiments of the vertical gardening apparatus may be described in terms of cultivating a plant in a root-end-up or root-end-down orientation, the vertical gardening apparatus is not so limited, and may be adapted to cultivate multiple plants in multiple orientations.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A vertical gardening apparatus, comprising:
a rectangular flat panel made of a bendable material,
the flat panel comprising a first side with first fastening mechanisms; and
the flat panel comprising a second side with second cooperating fastening mechanisms, the second side being adjacent to the first side,
wherein the flat panel is configured to enable the flat panel to be curled so that the first fastening mechanisms attach into respective second cooperating fastening mechanisms, thereby forming a conical apparatus with a small opening on a bottom of the conical apparatus and a large opening on a top of the apparatus.

2. The apparatus as recited in claim 1, wherein the flat panel is made out of aluminum or stainless steel.

3. The apparatus as recited in claim 1, wherein the flat panel is made out of polished aluminum.

4. The apparatus as recited in claim 1, wherein the flat panel is made from a shiny material that reflects light.

5. The apparatus as recited in claim 1, further comprising a mounting hole located in the flat panel across from a corner where the first side and second side meet.

6. The apparatus as recited in claim 1, wherein the first fastening mechanisms are buttons and the second cooperating fastening mechanisms are holes.

7. A vertical gardening apparatus, comprising:
a conical shaped apparatus, formed from a rectangular flat panel made of bendable material;
the flat panel comprising a first side with first fastening mechanisms and a second side with second cooperating fastening mechanisms, the second side being adjacent to the first side, the first fastening mechanisms on the first being attached to the second cooperating fastening mechanisms on the second side thereby maintain a conical shape of the conical shaped apparatus; and
a seam between the first side and the second side.

8. The apparatus as recited in claim 7, wherein the flat panel is made out of aluminum.

9. The apparatus as recited in claim 7, wherein the flat panel is made out of polished aluminum.

10. The apparatus as recited in claim 7, wherein the flat panel is made from a shiny material that reflects light.

11. The apparatus as recited in claim 7, further comprising a plant inside the conical shaped apparatus.

12. The apparatus as recited in claim 11, wherein the plant comprises roots and vegetation, the roots being inside the conical shaped apparatus and the vegetation passing through a hole in the conical shaped apparatus and being outside the conical shaped apparatus.

13. The apparatus as recited in claim 12, further comprising a mounting hole located on a top portion of the conical shaped apparatus.

14. The apparatus as recited in 13, further comprising a deflection area below the mounting hole which is a surface at a back of a top of the conical shaped apparatus and an open front configured to direct liquids to flow inside the conical shaped apparatus.

15. The apparatus as recited in claim 7, wherein the first fastening mechanisms are buttons and the second cooperating fastening mechanisms are holes.

16. A method to assemble a vertical gardening apparatus, the method comprising:
providing a rectangular flat panel made of a bendable material, the flat panel comprising a first side with first fastening mechanisms, the flat panel comprising a second side with second cooperating fastening mechanisms, the second side being adjacent to the first side;
curling-up the flat panel so that the first side is aligned with the second side; and
attaching the first fastening mechanisms on the first side to the second cooperating fastening mechanisms on the second side, thereby forming a conical apparatus with a seam between the first side and the second side.

17. The method as recited in claim 16, further comprising inserting a plant inside the conical apparatus after the conical apparatus is formed.

18. The method as recited in claim 17, further comprising hanging the conical apparatus wherein the plant grows in an upside-down orientation inside the conical apparatus with the vegetation hanging downward outside of an opening in the conical apparatus and the roots of the plant being inside the conical apparatus.

19. The method as recited in claim 17, further comprising hanging the conical apparatus wherein the plant grows in an upright orientation inside the conical apparatus with the vegetation growing out of a top of the conical apparatus and the roots of the plant being inside the conical apparatus.

20. The method as recited in claim 17, further comprising placing a plant on the flat panel before the curling, wherein the curling forms the conical apparatus around the plant.

21. The method as recited in claim 20, further comprising hanging the conical apparatus wherein the plant grows in an upside-down orientation inside the conical apparatus with the vegetation hanging downward outside of an opening in the conical apparatus and the roots of the plant being inside the conical apparatus, wherein roots of the plant are larger than a bottom hole preventing the plant from falling out.

22. The method as recited in claim 18, further comprising hanging the conical apparatus wherein the plant grows in an upright orientation inside the conical apparatus with the vegetation growing out of a top of the conical apparatus and the roots of the plant being inside the conical apparatus.

23. The method as recited in claim 16, wherein the first fastening mechanisms are buttons and the second cooperating fastening mechanisms are holes.

24. A conical apparatus, comprising:
a first panel made of a bendable material, the first panel comprising a first side with first fastening mechanisms and comprising a second side with second cooperating fastening mechanisms, the second side being adjacent to the first side,
a second panel made of a bendable material, the second panel comprising a first side with first fastening mechanisms and comprising a second side with second cooperating fastening mechanisms, the second side being adjacent to the first side,
the first fastening mechanisms on the first side of the first panel connected to the second cooperating fastening mechanisms on the second side of the second flat panel,
the first fastening mechanisms on the first side of the second panel connected to the second cooperating fastening mechanisms on the second side of the first flat panel,
wherein the first panel and second panel are curled with a small opening on a bottom of the conical apparatus and a large opening on a top of the conical apparatus.

25. The apparatus as recited in claim 24, further comprising a plant inside the conical apparatus.

26. The apparatus as recited in claim 24, wherein the first fastening mechanisms are buttons and the second cooperating fastening mechanisms are holes.

27. A method to form a conical apparatus,
providing a first panel made of a bendable material, the first panel comprising a first side with first fastening mechanisms and comprising a second side with second cooperating fastening mechanisms, the second side being adjacent to the first side;
providing a second panel made of a bendable material, the second panel comprising a first side with first fastening mechanisms and comprising a second side with second cooperating fastening mechanisms, the second side being adjacent to the first side;
attaching the first fastening mechanisms on the first side of the first panel to the second cooperating fastening mechanisms on the second side of the second flat panel;
curling the first panel and the second panel;
attaching the first fastening mechanisms on the first side of the second panel to the second cooperating fastening mechanisms on the second side of the first panel to create the conical apparatus; and
inserting a plant into the conical apparatus.
